(19) United States
(12) Patent Application Publication
(10) Pub. No.: US 2010/0231400 A1
(43) Pub. Date: Sep. 16, 2010

(54) LIGHTING ACTIVATION SYSTEMS AND METHODS

(75) Inventors: Paul J. Von Mohr, Amelia Island, FL (US); Dennis Wyman, Amelia Island, FL (US); Mark Williams, Moss Beach, CA (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: MEO MIO, LLC, Amelia Island, FL (US)

(21) Appl. No.: 12/303,788

(22) PCT Filed: Oct. 9, 2008
(86) PCT No.: PCT/US08/79362

§ 371 Date: Dec. 8, 2008

Related U.S. Application Data
(60) Provisional application No. 60/998,210, filed on Oct. 9, 2007.

(51) Int. Cl. G08B 21/00

(52) U.S. Cl. 340/665

(57) ABSTRACT

A system and method for activating one or more lights or other devices using one or more activation devices including electronic circuitry. The electronic circuitry of the activation devices includes an activation sensor, based on which the lights or other devices are activated. Activation sensors include motion, sound or light sensors. With transmitters the activation devices can activate remote lights or other devices including receivers. Activation devices can be coupled with or apart form the lights or other devices.

### CROSS-REFERENCE TO RELATED APPLICATION

This application claims the benefit of U.S. Provisional Application Ser. No. 60/998,210, filed on Oct. 9, 2007, the contents of which are hereby incorporated by reference in their entirety.

### FIELD OF THE INVENTION

This invention and its various embodiments relate generally to systems and methods for activating lighting, and more particularly relate to systems that can be activated by one or more pressure switches.

### BACKGROUND OF THE INVENTION

It is well known in the prior art to utilize an individual light or sets of lights that are operated by a wall-mounted switch or a switch incorporated into a stand-alone lamp. Often the fixed location of the wall-mounted switch or switches is inconvenient or problematic based on factors like the physical condition of the user and the conditions in the environment of use. For example, a child will have difficulty finding a light switch at night should he or she need to go to the bathroom, become scared or choose to leave his or her bed for other reasons. Likewise, an elderly person may be disoriented when arising in the dark such that finding a light switch may be difficult. Even where sufficient light may be available to locate the switch, a disabled individual may have difficulty physically reaching the switch location.

### SUMMARY OF THE INVENTION

It is an object of this invention and its various embodiments to provide a pressure-switch activated lighting system and method for the interior of buildings, such that simply stepping onto a floor cover disposed in a convenient location or squeezing a plush toy, pillow or wrist band activates one or more lights to provide illumination in the dark, in each instance using battery power and without the need for the use of line current.

It is a further object to provide such a system and method that activates local and remote lights, preferably battery powered lights, through radio-frequency transmission.

Other objects not expressly set forth are anticipated as well, and such will be inherent in the disclosure to follow.

In accordance with one embodiment of this invention, a system and method for activating remote lights is provided in connection with a floor cover member such as a rug or mat having pressure switch means that activates a radio frequency (RF) transmitter on board when a user steps onto the floor cover member. The system further preferably comprises at least one remote light containing a corresponding RF receiver, such that the remote light is turned on when a signal from the RF transmitter is received. Most preferably, the remote lights, the transmitter and the floor cover member are battery powered, such that placement is not limited to locations with access to power outlets. The transmitter and receivers preferably operate in pulse or periodic sleep mode to reduce power consumption.

In other embodiments, the remote lights include transceivers that permit information to be relayed back to the on-board transmitter and/or particular groupings of lights. Timers are preferably incorporated in the remote lights, and the timers may have override switches to be controlled by the user. The floor cover member may contain a primary light or have a light removably attached thereto. Multiple transmitters may be employed within a house, and particular groupings of lights may be dedicated to one or more transmitters.

In still further alternative embodiments, the transmitter may be incorporated in other devices such as a plush toy, a pillow, a wristband, or similar articles.

In yet another embodiment, a wireless lighting activation system includes a first light and a first activation device having first battery-powered electronic circuitry including a first activation sensor. The first electronic circuitry is configurable to activate the first light in response to the first activation sensor. The first light can be attached to the first activation device or remote therefrom. In the case of a remote light, the first light can have a receiver for receiving a first light activation signal transmitted by a transmitter in the first battery-powered electronic circuitry. In the case of multiple remote lights, each remote light can have a receiver for receiving discrete activation signals and the first electronic circuitry can be configured transmit any combination of the activation signals. Also, multiple activation devices can be employed, each having electronic circuitry that can be configured to transmit any combination of the activation signals. The first and/or second activation devices can be attached to lights, such that a light/activation device combination is effective to both receive and transmit activation signals.

According to various aspects of this embodiment, the first activation sensor includes at least one of: a sound sensor, a motion sensor and a light sensor. If a motion sensor is used, the motion sensor can include at least one of: a passive infrared sensor for detecting motion of body heat remote from the passive infrared sensor and a jiggle switch for detection motion of a body to which the switch is attached. If a sound sensor is used, the sound sensor can be configured to detect a specific sound, including a fire alarm tone or dog bark.

### BRIEF DESCRIPTION OF THE DRAWINGS

FIG. 1 is a top plan view of a floor cover member having a pressure sensitive lighting system in accordance with a first embodiment of this invention.

FIG. 2 is a side view of a portion of the embodiment shown in FIG. 1.

FIG. 3 is a perspective view of the floor cover member of FIG. 1 adjacent a bed.

FIG. 4 is an exploded side view of the layers comprising the floor cover member shown in FIG. 1.

FIG. 5 is an exploded perspective view of the layers of the floor cover member shown in FIGS. 1 and 4.

FIG. 6 is a top view of a foam layer portion of the floor cover member shown in FIGS. 1, 4 and 5.

FIGS. 7-10 are illustrations of battery powered remote lights in accordance with another aspect of this invention.

FIGS. 11 and 12 are representative illustrations of an alternate embodiment for a plush toy transmitter system employing a pressure-sensitive lighting system according to this invention.

FIGS. 13-16 are schematics of representative circuitry for a transmitter and a receiver useful with the embodiments shown in FIGS. 1-12.

### DETAILED DESCRIPTION OF PREFERRED EMBODIMENTS

The invention and its various embodiments will now be described with reference to the drawings.

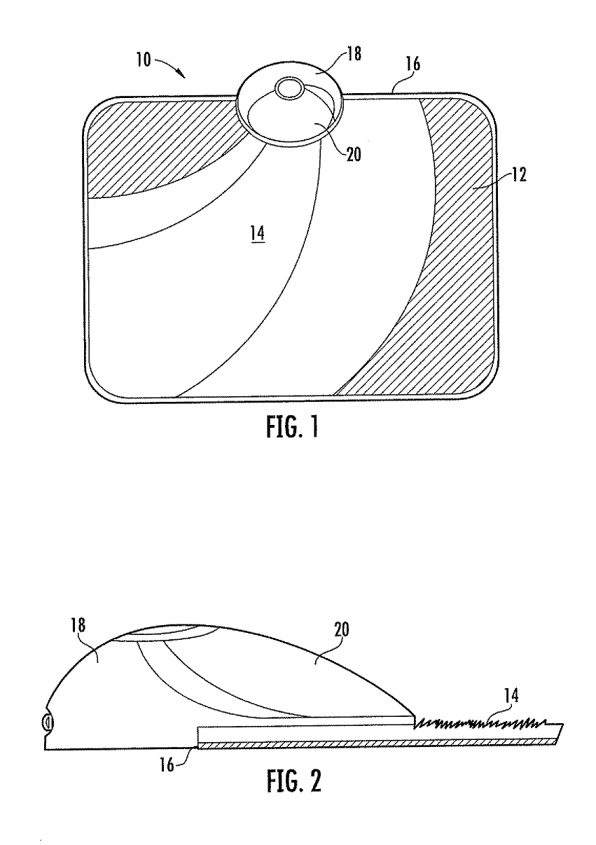

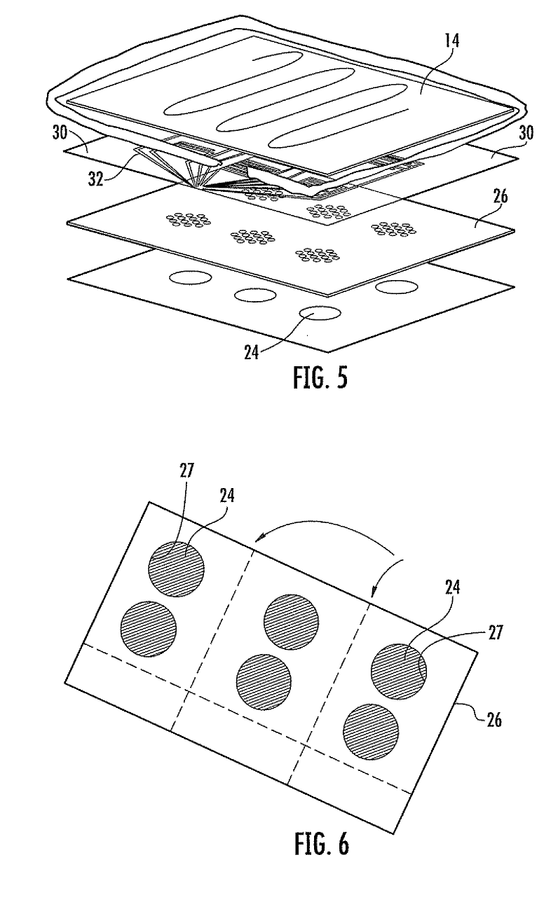

In a first embodiment shown in FIGS. 1-8, the invention comprises a light system 10 with a floor cover member 12 preferably in the form of a rug or mat sized to be positioned next to a bed as shown in FIG. 3, along a hallway or in a doorway, at the top or bottom of stairs or any other location as desired for its purpose, which is to provide a low level light by applying pressure on the top surface 14 of the member 12 without the need for searching for a wall-mounted light switch or a lamp switch in the dark and using only battery power. Preferably, the floor cover member 12 incorporates a light 20 within a light housing 18 embodied in or attached to the floor cover member 12, such that lighting is provided when a user steps out of bed, into a hallway or under similar circumstances thereby activating the light 20. In this embodiment, the housing 18 is positioned along the peripheral edge portion 16 of the floor cover member 12 to permit the peripheral edge portion 16 to be positioned adjacent the edge of a bed and avoid a trip or fall hazard.

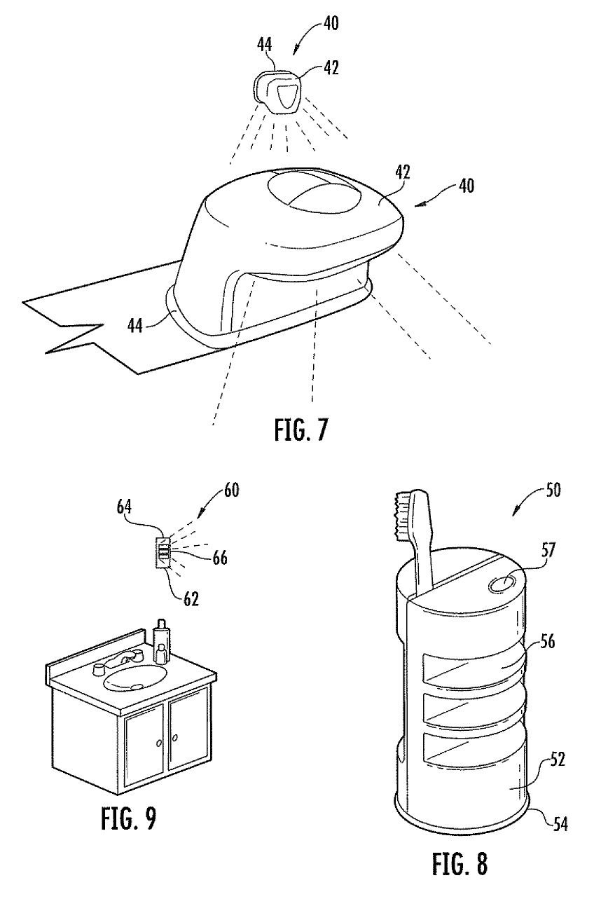

One example of a construction for the floor cover member 12 as a mat suitable to provide pressure sensitive switching for the light 20 will now be described with reference to FIGS. 4-6.

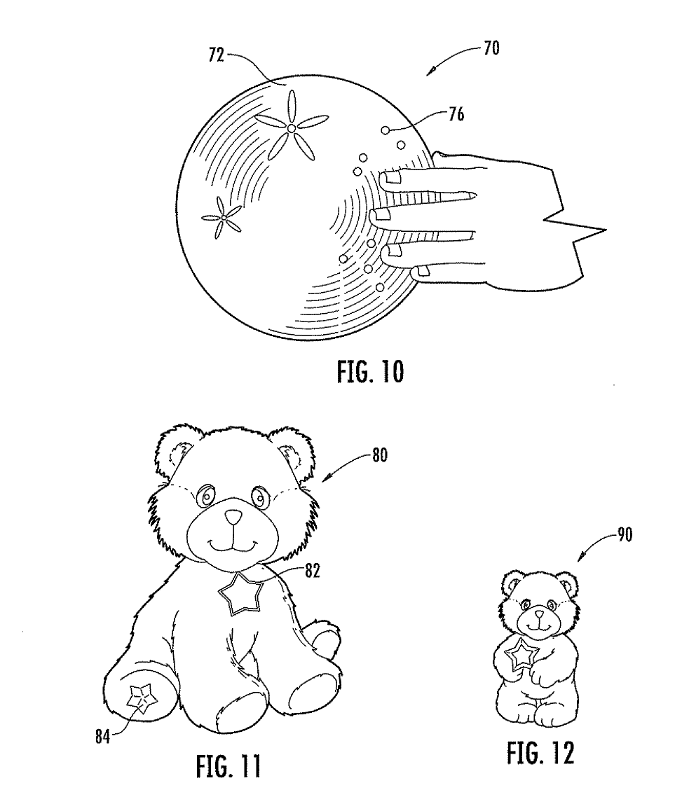

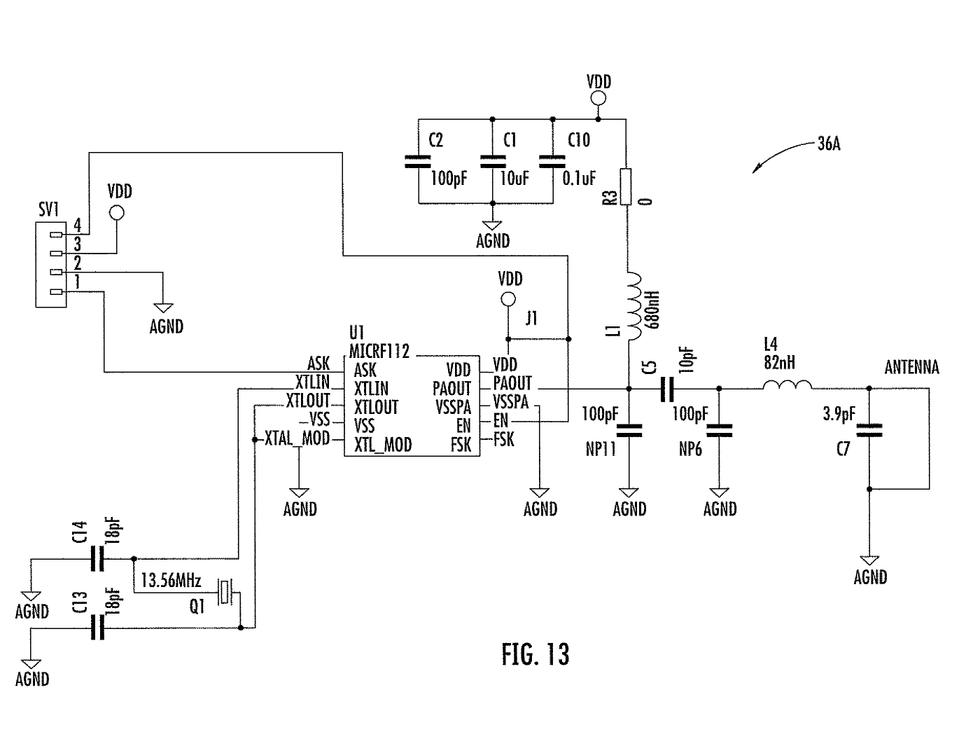

As shown in the exploded side view of FIG. 4, the mat 12 includes a EVA foam base layer 22 having a conductive ink layer 24 disposed on the upper surface thereof. An upper fabric layer 28 provides the top surface 14. The mat 12 further comprises intermediate foam and Mylar layers 26 and 30 respectively, positioned between the upper layer 28 and the bottom layer 22. A conductive layer 32 of fingers 33 described in greater detail below is deposited on the bottom surface of the Mylar layer 30. The entire series of layers 22, 24, 26, 28, 30 and 32 are sandwiched together with a nylon web binding 34 at the edge of the mat 12, including the peripheral edge portion 16. The various layers are also shown in an exploded perspective view in FIG. 5, with the EVA foam base 22 and portions of the conductive ink layer 24 depicted in a top plan view in FIG. 6. The following describes these layers and conductors in greater detail:

(1) the fabric top layer 28 is any fabric or rug-like material suitable for the particular end use—residential, outdoor, institutional, etc.—and decorated as desired.

(2) the thin Mylar layer 30, or other plastic sheet of similar characteristics, is preferably approximately 0.1 to 0.15 mm thick, is sturdy enough to remain flat, withstand pressure and hold the conductive ink layer 32, and flexible enough to easily bend under pressure. The Mylar layer 30 is thick enough to avoid the “crinkling” sound common to thinner Mylar when stepped upon or bent.

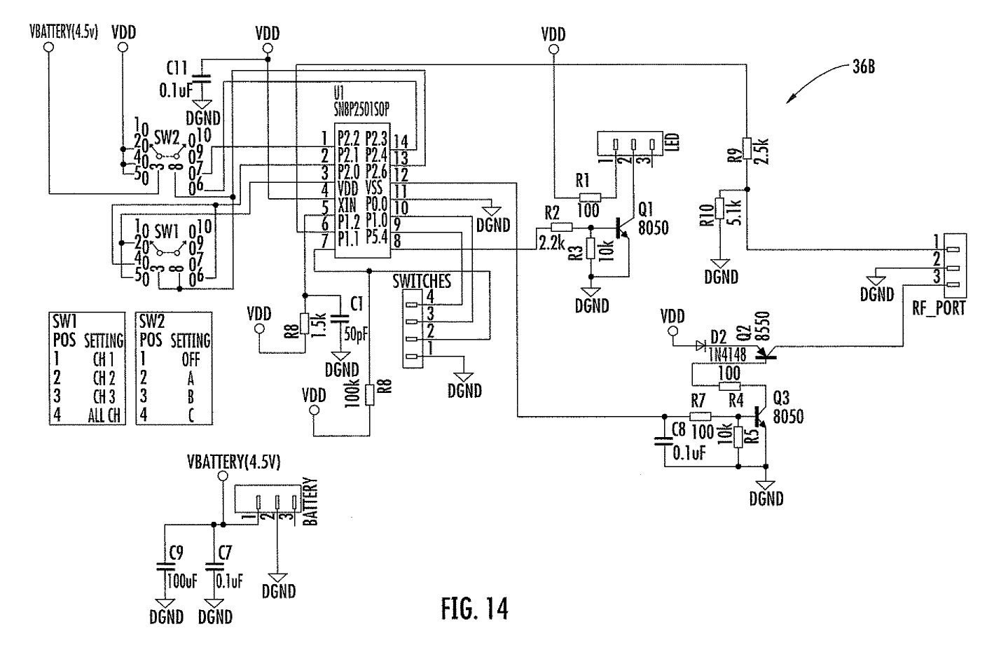

(3) the electronic conductive carbon-based ink layer 32 is printed, silk-screened or otherwise applied onto the bottom side of the Mylar layer 30. The ink layer 32 patterns are printed in such a way that areas of interwoven fingers 33 (FIG. 5) are spread throughout the active area of the mat 12. Half the fingers 33 on one side of an area serve as an input to circuit 36 and the other half of the fingers 33, printed inbetween the first set of fingers 33, are connected to an output of an operative electronic chip in FIG. 7. The fingers 33 are thus disposed on the bottom of the Mylar layer 30 in the shape of interlocking multi-tined forks, with the fingers 33 of one not touching the fingers of the other. The switching areas of the interwoven fingers 33 are, in a specific example, approximately 3.5 inches square and spread throughout the area of the mat 12 in a two by three pattern. Each area has its own input and output going to the housing 18. The 2 by 3 pattern is preferable for retail packaging and reliability, as it allows the mat 12 to be folded in a tri-fold manner. The use of plural fully independent switch areas allows the mat to function properly even if one or more switch areas are permanently or temporarily inoperative. For example, if the leg of a night stand is placed onto the mat 12, a normal switch pattern sees the switch closed and always have the light on, or never have the light on. But with plural independent areas, the micro-controller of FIG. 7 is programmed to recognize that one area remains closed and to ignore, but keep checking should the switch re-open, (in this case, if the leg of the night stand is moved). Also, by having plural switch areas, if a single finger 33 breaks, all the other areas remain fully functional. Additionally, the micro-controller of FIG. 7 can also be programmed to determine, based on the closing, or lack thereof, of successive switches, whether a user is standing in one location or moving across the mat 12. As a result, the micro-controller could limit light activation based thereon. For instance, motion across the mat 12 could be ignored, while standing in place on the mat 12 for a predetermined time interval could trigger light activation.

(4) the spacer foam layer 26 includes openings 27 and functions as an electrically insulating spacer positioned below the conductive ink fingers 33 on the bottom of the Mylar layer 30. The layer 26 is die cut to fit snugly in the sandwich with die cut holes 27 approximately 1 inch in diameter. The thickness and/or resiliency of the spacer foam layer 26 can be selected such that contact between the fingers 33 requires application of at least a minimum predetermined force. Weight sensitivity can thereby be incorporated into the mat 12, such that activation of the mat by lighter objects, such as many household pets, can be inhibited. Alternately, the spacer foam layer 26 can be formed from a compressible dielectric, with or without openings, such that the fingers 33 and foam layer 26 form a capacitive pressure sensing assembly, with a change in capacitance due to compression of the dielectric being proportional to the force applied to the mat 12. With such an arrangement, the micro-controller can be programmed to trigger light activation based on or more specific ranges of applied force.

(5) the EVA foam backing layer 22 or similar material acting as a non-skid bottom. The top surface 23 is coated with the conductive ink 24 at locations chosen to correspond to areas of the conductive fingers 33 on the underside of the Mylar layer 30, preferably in a circular pattern. This circle of conductive ink 24 acts to close a circuit between adjacent ones of the interwoven fingers 33 on the bottom of the Mylar layer 30. When the mat 12 is stepped upon, the Mylar layer 30 deforms, the spacer foam layer 26 is compressed, and adjacent fingers 33 are shorted across the ink 24 on the top surface of the EVA foam layer 22 to complete a circuit, thereby activating the light 20 and any of the secondary remote lights described below.

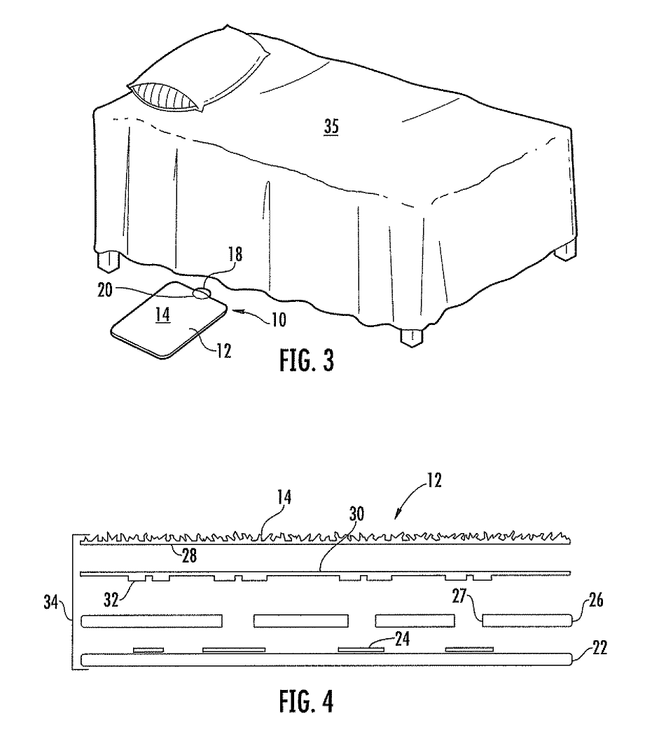

With particular reference to FIGS. 1 and 3, it will be appreciated that the lighting system 10 comprising the mat 12 and its associated light 20 may be placed adjacent a bed 35 with the mat 12 extending somewhat under the edge of the bed so that the protruding housing 18 does not form a trip hazard when a person exits the bed and steps upon the top surface 14 of the mat 12. As best seen in FIG. 2, the housing 18 has a profile and curved surfaces so as to reduce the likelihood of injury to a user getting out of the bed 35 and stepping upon the mat 12.

A representative example of a method for assembling the mat 12 is presented as follows. The fabric piping 34 is sewn along the outside edge to hold the top fabric layer 30 to the EVA foam layer 22. Additionally, sewing on the inner parts provides a decorative appearance and also holds the Mylar layer 30 and foam layer 26 in place. The ink layer 32 is printed to the outside edge of the Mylar layer 30, and connects to the microcontroller board in FIG. 7 by compressing the Mylar layer 30 down with a spring metal bar or rubber piece. The light housing 18 is attached to the rug sandwich using screws to compress and hold the top layer 28 and EVA foam layer 22 together between a “jaw” of plastic that protrudes from the housing 18. The covering mat 12 is machine washable or disposable with a removable housing 18.

In accordance with another aspect of this invention, the system 10 is further provided with one or more secondary remote lights, such as lights 40, 50, 60 and 70 shown in FIGS. 7-10. As with the primary light 20 and its corresponding housing 18, each of the secondary lights is provided with a corresponding light housing 42, 52, 62 and 72. Further, each of the secondary remote housings 40, 50, 60 and 70 are provided with means for attachment to an area remote from the primary light housing 18, such as the adhesive layers 44, 54 and 64 shown in FIGS. 7, 8 and 9. As shown in FIG. 8, the secondary remote light housing 50 may be incorporated into an article useful for other purposes, such as a holder for a toothbrush 58.

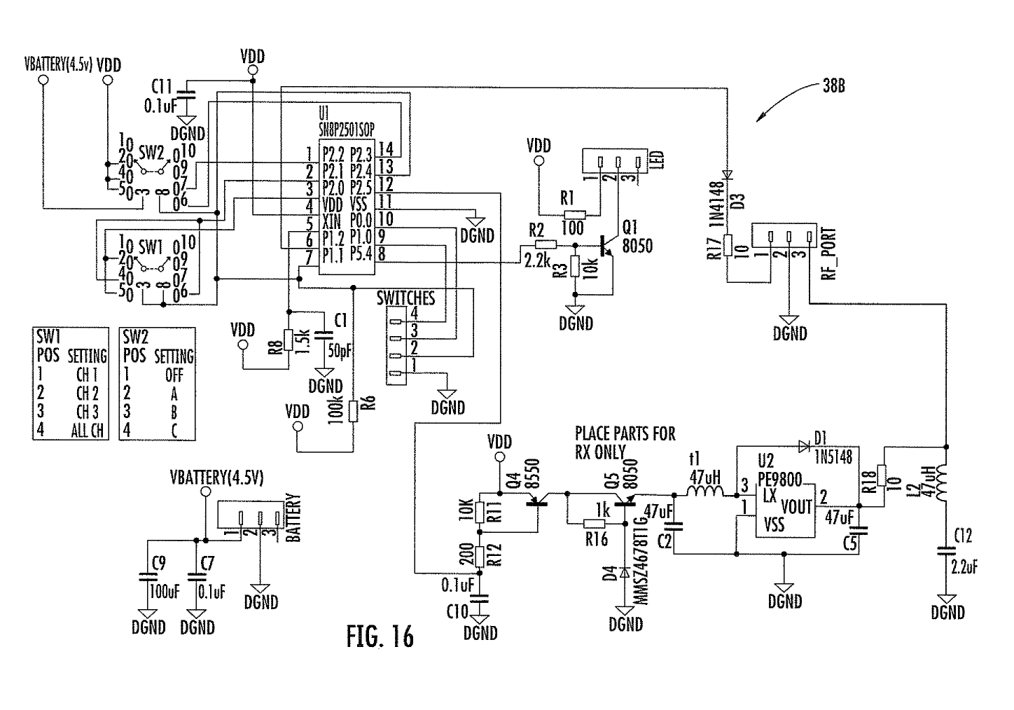

Control over the secondary remote lights 40, 50, 60 and 70 is provided by a high frequency, digital RF transmitter fitted into the housing 18 for the primary light 20 positioned along the peripheral edge 16 of the mat 12. One example of a circuit for the digital RF transmitter is shown in FIGS. 13 and 14 and referred to by the general reference numerals 36A and 36B, although it will be appreciated by those skilled in the art that a variety of circuit configurations are suitable. Use of a digital RF transmitter such as circuit 36 lends to the system the absence for a need of a long antenna where the transmissions from the transmitter 36 are being broadcast over an entire house with minimal interference from other radio-frequency sources. The transmitter circuit 36A and 36B is operated solely by battery power and is multi-channel, so that several transmission channels can be transmitted from the primary light housing 18 without cross triggering.

Correspondingly, each of the remote light housings 40, 50, 60 and 70 include receivers that operate by battery only in a low power mode but which are awakened on a regular basis to “listen” for a digital activation signal from a corresponding transmission channel of the transmitter 36A and 36B, with the transmitter transmitting in pulses over an extended time to allow “sleeping” receivers enough time to wake, receive and decode a corresponding signal. A circuit configuration suitable for use as the receivers is shown in FIGS. 15 and 16 and referred to generally by the reference numerals 38A and 38B. In order to save power, light sensors can be built into the housings 18, 40, 50, 60 and 70 to prevent activation of the corresponding lights 20, 40, 50, 60 and 70 when there is sufficient ambient light. The small size of the housings and the low power consumption of the transmitter and receiver circuits allows the electronic units to be quite small, with corresponding small housings for same. Each transmission channel of the transmitter 36 is digitally encoded with a unique transmission code to prevent a false trigger of the remote lights by other sources.

Alternative embodiments and features of this invention are described next:

1. A programmable lighting sequencing on the mat (i.e. the transmitter is adapted to control the amount of intensity of light use such as brightness and direction).

2. A programmable lighting sequence on the receiver is adapted to control the amount of light intensity of brightness and direction.

3. A “battery low” indicator on the covering member 12 and/or the receiver 38 having a flash or audio tone signal similar to a smoke alarm signal to alert the user of the need for a battery change.

4. Programmable RF signals of different control codes for multiple mats and transmitters 36 and receivers 38 to be used in conjunction with each other. Control codes are set by a switch location (code A or code B, for example) or have a “learn” mode such that the mat sends a unique code to the nearest remote lamp to establish their unique communication code, such that the number of channels within an area may be over 100. The learn code is also accomplished by temporarily connecting the mat to the light with a short cord. Examples of situations where this would be beneficial include an elderly couple having two coverings on opposite sides of a bed. When one user gets up and steps on the mat both are illuminated. Alternatively, a family with an elderly person in the home as well as a young child each has a mat in their respective rooms. When the child steps on the mat to go the bathroom, the mat lights up as well as specific receiving lights in the hallway and bathroom. However, the mat in the elderly person's bedroom does not illuminate nor do remote lights in the elderly person's bedroom. Additionally, if the elderly person steps on the mat an audio and light receiver activates in the parent's room to alert that the elderly person needs assistance. The receiver is in the form of a base unit next to the parent's bed or it can be in the form of a portable unit such as a wrist unit, key fob unit or pillow attachment unit. The base or portable unit becomes a transceiver that can activate the same and additional lights to help parent navigate in the dark home to check on elderly person. With multiple children and/or elderly persons, the base or portable unit could provide a light and/or audio indications allowing the parent to identify the origin of the activation signal.

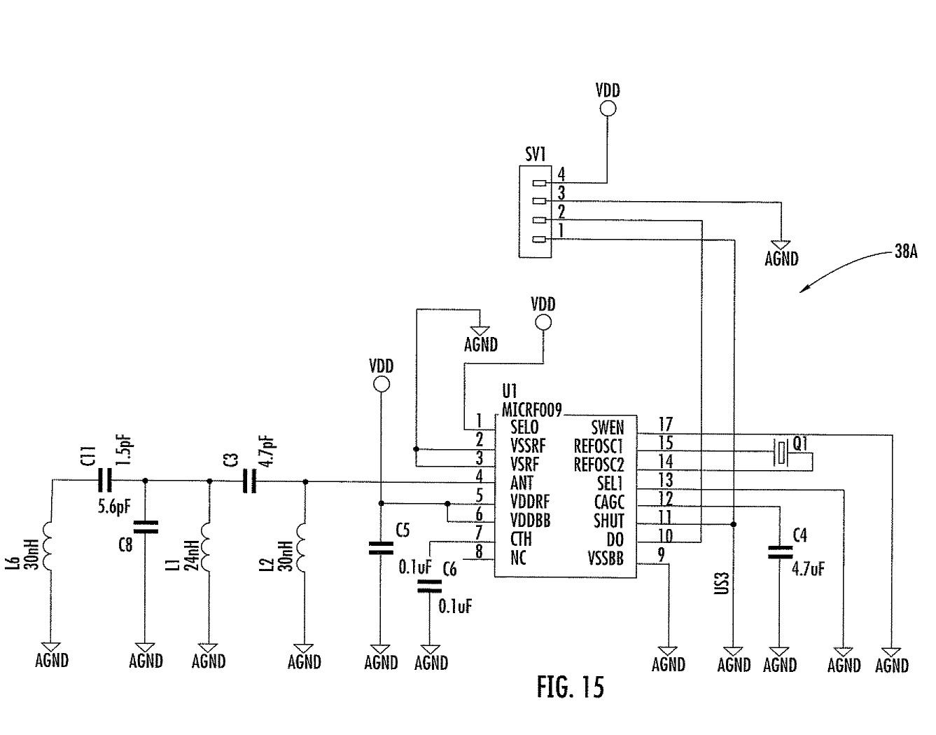

5. In another arrangement, the mat 12 does not have a light built into or attached to it. The light unit may also be wireless but activated once the user steps on the mat. Another example would be if the user hugs or presses a pillow, toy, or similar device such as the plush toy 80 shown in FIGS. 11 and 12 to cause a light to activate.

6. The receiver and transmitting devices are waterproof for camping and boating uses (i.e., outdoor uses).

7. The mat 12 does not have a light built into or attached and is activated by an activation sensor other than a pressure sensor, and the activation sensor can be incorporated into an activation device other than the mat 12. For example, activation devices could employ activation sensors including motion sensors, sound sensors and/or light sensors. The motion sensor could be a passive infrared (PIR) sensor that detects the motion of body heat remote from the device. The PIR or similar sensor could be in, for instance, a wall- or ceiling-mounted activation device capable of detecting motion over a wide area of room or other space, or a desk or nightstand mounted activation device that only detects motion within a limited range, such as one foot or less. The motion sensor could also be a “jiggle sensor” that detects motion of an object to which the activation device is attached. For example, the activation device could be clipped to a dog collar or a child's pajamas or other clothes. Sound sensors could be used to automatically trigger activation based on noises of concern such as fire alarm tones or dog barks. Light sensors could be used to automatically activate lights upon detecting a decrease in light level. For example, when a child turns off the overhead bedroom light, a mat or bed-side light is activated to allow the child to safely reach the bed.

8. The receiver lights can be in many forms including but not limited to bedside lights, wall hanging lights or sconces, jewelry, watches that user can wear, waterproof lights, floor lights or the like. Activation devices can also be incorporated into the receiver lights, such as in the case of the base or portable units above, or other applications.

9. The light module in the mat 12 is removable for use as a flashlight.

10. Other embodiments for the transmitter means include for example a wrist band or necklace that activates remote lights while providing a low illumination “flashlight” feature, a pillow case adornment, slippers as transmitters, activating remote lights when stepped into, or receivers, when the mat is stepped upon, the lights built into the slippers light up for finding them in the night, and providing a “headlight” when walking, outdoor use (e.g., at front door, garage entryway, etc.), outdoor vehicle use, where a heavy duty mat is triggered by the weight of a car in a garage or driveway, a plush/plastic toy, such as for example the locations 82 and 84 on the plush bear 80 of FIGS. 11 and 12, is used to activate the remote lights. The plush itself may glow and/or have reassuring sounds, speech or music generated when squeezed while activating a themed night stand light, light the way to the parent's room or the way to the bathroom.

11. An encoded wrist band or similar device is remotely triggered by a staff member to quickly identify and locate a patient in a dark environment.

12. The transmitter mat also contains a mechanism to produce sounds and music as a soothing end of the day after the light goes out, or the rug generates fun sounds when activated, particularly when matched with a themed rug.

13. As the remote lights are most preferably battery powered such that there is no power cord, they are designed to be placed on a horizontal surface such as a bathroom counter or on a small nail or hook to hang on the wall or hang on a door knob with a simple hanger. Also, the remote lights can be provided as a “tube light”; that is, a long, thin “rope” of lights that can be placed along a wall, wrapped around a banister or coiled around a doorknob.

14. The remote light comprises a stand-alone lamp powered by the house's electrical system, where the receiver closes a switch to allow current to reach the lamp, the lamp switch being kept in the “on” position.

15. The battery operated remote lights are placed where no lights exist, such as in a closet, garage or basement, so these hard to reach places can have lighting without wiring. The remote lights can be incorporated in functional objects, such as for example the toothbrush holder shown in FIG. 8.

16. The remote and transmitter lights automatically turn off after a preset time for power savings and longer battery life. Time can be determined with a rotary or digital switch on the mat 12 to set the amount of time the lights stay on. In one embodiment, the mat light 20 can be turned off manually by stepping off the rug, waiting more than 3 seconds and stepping back on the rug. Remote lights have a “stay on longer button”, such as button 57 in FIG. 8, which the user can press to keep the remote on longer. In another embodiment, the lights slowly dim out to give the user time to retrigger if desired. In combination with receiver units that include activation devices, when a plurality of activated receiver lights begins to dim or turn off following a predetermined time, but the user wishes the lights to remain on, the user can, by re-activating one of the receiver lights, re-activate some or all of the other receiver lights. For instance, the user initially steps on the mat, in response to which the microcontroller is programmed to activate the mat light and send a signal to activate receiver lights in the hall and kitchen. The lights are configured to remain on for ten minutes and then dim to off. The receiver lights are configured such that, if the user re-activates any of the receiver lights within the ten minutes, the receiver light that is re-activated will send a re-activation signal to the mat, which will, in turn re-activate the mat light all the receiver lights programmed for activation when that mat is stepped on.

17. The remote lights can also incorporate audio and vibrating activation in the event the mat 12 is activated to alert the parent or caregiver. The mat 12 is programmable to function on a delay or immediately upon activation. Delay consideration may be on the order of 3 minutes to alert parent or caregiver that the user has not turned off” the mat 12 while going back to bed.

18. It is also contemplated that in addition to the lighting feature, the transmit signal also notifies a switchboard, a PDA or a pager-type device at a nurses' station or other caregiver area that a patient is up and may need assistance. Similarly a portable “key fob” transmitter can be carried by the caregiver for activating the local low light and/or combination of light and audio signal or vibration “remote lighting”, or even just the mat light 20, or other receiver light, so that a bed check can be made without the disturbance of bright overhead lighting. This provides safety and assurance to the patient while providing a safer environment for the caregiver staff. In this embodiment, what has been described above as transmitters become “transceivers” that both receive and transmit for both greater safety and flexible features.

19. It will also be appreciated by those skilled in the art that the remote lights 46, 56, 66 and 76 can be programmed to be activated by more than one mat 12; for example, lights in a bathroom may be activated by multiple mats 12 in different bedrooms. Individual lights can be set for a specific one or all transmitter channels; for example, a bathroom light such as that depicted in FIGS. 9 and 10 can be set to respond to all transmitters, but a bedside light in one bedroom can be set to respond only to the specific mat 12 in that bedroom.

20. The present invention also includes the use of relay stations including electronic circuitry that allows extension of the effective range of activation signals transmitted from the mat 12 or other activation device to lights or other devices. Transmitter limitations, for example, size, power and/or regulatory restrictions, can limit the effective range of activation signals transmitted therefrom. As a result, a given activation device may have insufficient transmitter range to activate certain light(s) or other device(s). For example, an activation device in an upstairs bedroom may not be able to activate lights in a basement. A relay station located on the first floor can receive the activation signal and relay it to the basement lights. Relay stations can be programmable, or “smart”, such that it can relay activation, or re-activation signals to predetermined groups of lights or other devices based on user preferences. Relay stations do not necessarily need to be stand-alone devices, and can also be incorporated into lights or other devices. In the above example, the first floor relay station could be a transceiver associated with a first floor light that automatically relays signals that are not exclusively activation signals for the associated first floor light.

21. The present invention is not necessarily limited to use of the various activation devices with one or more lights. The present invention can also include activation systems for activating sound-generating devices, as well as for activating devices for other functions.

It will of course be appreciated by those skilled in the art that a variety of other modifications and changes to the embodiments shown in the drawings and described above may be made without departing from the spirit and scope of this invention.

What is claimed is:

1. A lighted floor covering comprising:
a mat member having a top surface, a bottom and a peripheral edge;
a light positioned along a side of the peripheral edge of the mat member; and
circuit means positioned within the mat member between the top surface and the bottom for activating the light in response to pressure applied by a user to the top surface.

2. The floor covering recited in claim 1, further comprising a housing for the light, the housing having a profile and curved surfaces so as to reduce the likelihood of injury to a user stepping onto the upper surface of the mat member.

3. The floor covering recited in claim 1 further comprising:
a second light having a radio-frequency receiver therewith; and wherein
the circuit means comprises a radio-frequency transmitter for transmitting a radio-frequency signal to the second light responsive to the pressure applied by the user to the top surface of the mat to thereby activate the second light.

4. The floor covering recited in claim 3 wherein the radio-frequency receiver comprises battery powered circuitry for intermittently detecting transmissions.

5. The floor covering recited in claim 1 further comprising a housing for the light, the light housing having a profile and curved surfaces so as to reduce the likelihood of injury to a user stepping onto the mat.

6. The lighted floor covering recited in claim 1 wherein the circuit means positioned between the top surface and the bottom for activating the light further comprises:
an upper layer;
a bottom layer; and wherein
the circuit means comprises plural spaced interdigitated conductive fingers disposed between the upper layer and the bottom layer, the figures disposed such that bridging of two adjacent fingers causes current to flow and activate the light.

7. The lighted floor cover recited in claim 6 further comprising:
an insulated layer disposed between the upper layer and the bottom layer, with the fingers deposited along a bottom surface of the insulated layer;
a conductive layer on an upper surface of the bottom layer; and
an intermediate foam layer between the conductive layer and the fingers, the foam layer having plural openings therein permitting a circuit connection to be made at least two fingers across the conductive layer through one of the openings when the user applies pressure to the top surface of the mat.

8. A wireless lighting activation system comprising:
a first light; and
a first activation device having first battery-powered electronic circuitry including a first activation sensor;
wherein the first electronic circuitry is configurable to activate the first light in response to the first activation sensor.

9. The system recited in claim 8, wherein the first light is attached to the first activation device.

10. The system recited in claim 8, wherein the first light is remote from the first activation device and includes a first receiver for receiving a first light remote activation signal from the first activation device, and the first electronic circuitry of the first activation device includes a first transmitter and is configurable to transmit the first light remote activation signal in response to the first activation sensor.

11. The system recited in claim 10, further comprising a second light;
wherein the first electronic circuitry is further configurable to activate the second light in response to the first activation sensor.

12. The system recited in claim 11, wherein the second light is remote from the first activation device and includes a second receiver for receiving a second light remote activation signal from the first activation device, and the first electronic circuitry of the first activation device is further configurable to transmit the second light remote activation signal in response to the first activation sensor, such that the first activation device is operable to transmit the first light remote activation signal, the second light remote activation signal or both the first and second light remote activation signals in response to the first activation sensor.

13. The system recited in claim 10, further comprising a second activation device having second battery-powered electronic circuitry including a second activation sensor;
wherein the second electronic circuitry is configurable to activate the first and second lights in response to the second activation sensor, such that the second activation device is operable to activate the first light, the second light or both the first and second lights in response to the second activation sensor.

14. The system recited in claim 13, wherein the first light is attached to the second activation device.

15. The system recited in claim 8, wherein the first activation sensor includes at least one of: a sound sensor, a motion sensor and a light sensor.

16. The system recited in claim 15, wherein the first activation sensor includes a motion sensor and the motion sensor includes at least one of: a passive infrared sensor for detecting motion of body heat remote from the passive infrared sensor and a jiggle switch for detection motion of a body to which the switch is attached.

17. A method for providing battery-powered lighting, the method comprising the steps of:
providing a relatively thin, flat and flexible mat having a top and a bottom, and dimensioned to be placed alongside a bed or similar location;
fitting a pressure-sensitive switch with associated battery-powered circuitry within the interior of mat between the top and bottom;
fitting a light housing with a light therein along a peripheral edge of the mat; and
activating the light within the housing by applying pressure to the top of the mat.

18. The method recited in claim 17 wherein the step of fitting the pressure-sensitive switch comprises the steps of:
inserting an insulating layer between the top and bottom of the mat;
depositing spaced interdigitated conductive fingers on a surface of the insulated layer such that adjacent fingers are not in physical contact unless pressure is exerted on the top of the mat;
depositing a conductive layer spaced from and opposite the conductive finger; and
bridging adjacent fingers across the conductive layer when pressure is exerted on the top of the mat.

19. The method recited in claim 18 further comprising the steps of:
inserting a non-conductive foam layer between the fingers and the conductive layer; and
forming openings in the non-conductive foam layer such that a circuit connection is made between at least two fingers across the conductive layer through one of the openings in the non-conductive foam layer when the user applies pressure to the top of the mat.

20. The method recited in claim 19 further comprising the steps of:
installing a second light remote from the mat;
fitting the mat with a radio-frequency transmitter and the second light with a radio-frequency receiver; and
activating the second light by transmitting a radio-frequency signal from the mat to the second light responsive to pressure applied by the user to the top of the mat.
